(19) United States
(12) Patent Application Publication
(10) Pub. No.: US 2014/0346317 A1
(43) Pub. Date: Nov. 27, 2014

(54) TOUCH SCREEN PANEL AND MANUFACTURING METHOD THEREOF

(71) Applicant: Samsung Display Co., Ltd., Yongin-city (KR)

(72) Inventor: Sun-Haeng CHO, Yongin-city (KR)

(73) Assignee: Samsung Display Co., Ltd., Yongin-city (KR)

(21) Appl. No.: 14/026,612

(22) Filed: Sep. 13, 2013

(30) Foreign Application Priority Data
May 24, 2013 (KR) 10-2013-0059013

(51) Int. Cl. G06F 3/042; G01J 1/42

(52) U.S. Cl. CPC G06F 3/0421; G01J 1/42
USPC 250/200; 29/830

(57) ABSTRACT

A method of manufacturing a touch screen panel includes forming first sensing electrodes on a first substrate, forming second sensing electrodes on a second substrate, and forming a photosensitive layer on the first sensing electrodes. The photosensitive layer is patterned to form photosensitive spacers spaced apart from one another in a first direction. The first substrate and the second substrate are joined together. The photosensitive spacers maintain a substantially constant space between the first sensing electrodes and the second sensing electrodes in a second direction.

### CROSS-REFERENCE TO RELATED APPLICATION

This application claims priority from and the benefit of Korean Patent Application No. 10-2013-0059013, filed on May 24, 2013, which is hereby incorporated by reference for all purposes as if fully set forth herein.

### BACKGROUND

1. Field

Exemplary embodiments relate to a touch screen panel and a method of manufacturing the touch screen panel.

2. Discussion

A capacitive touch screen panel, including a sensing electrode and another sensing electrode or ground electrode adjacent to the sensing electrode, senses a change in capacitance when a user's hand or conductive object having conductivity contacts the capacitive touch screen panel, thereby converting the contact position into an electrical signal. It is noted, however, that if a non-conductive object contacts a capacitive touch screen panel, the touch position may not be sensed. In this manner, a pressure-sensitive touch screen panel that recognizes at a contact position through a touch pressure may be utilized. A pressure-sensitive touch screen panel typically includes spacers interposed between a lower first sensing electrode and an upper second sensing electrode. The pressure-sensitive touch screen panel senses a change in capacitance generated by a reduction in the spacing between the first and second electrodes caused by a pressure exerted by a user's hand or object when the pressure-sensitive touch screen panel is pressed, thereby, detecting the contact position.

The above information disclosed in this Background section is only for enhancement of understanding of the background of the invention, and, therefore, it may contain information that does not form the prior art that is already known in this country to a person of ordinary skill in the art.

### SUMMARY

Exemplary embodiments provide a touch screen panel, and a method of manufacturing method the touch screen panel, which permits a uniform height for the spacers.

Additional aspects of the invention will be set forth in the detailed description which follows, and, in part, will be apparent from the disclosure, or may be learned by practice of the invention.

According to exemplary embodiments, a method of manufacturing a touch screen panel, includes: forming first sensing electrodes on a first substrate; forming second sensing electrodes on a second substrate; forming a photosensitive layer on the first sensing electrodes; patterning the photosensitive layer to form photosensitive spacers spaced apart from one another in a first direction; and joining the first substrate and the second substrate together. The photosensitive spacers maintain a substantially constant space between the first sensing electrodes and the second sensing electrodes in a second direction.

According to exemplary embodiments, a touch screen panel, includes: first sensing electrodes disposed on a first substrate; second sensing electrodes disposed on a second substrate opposite the first substrate; and photosensitive spacers disposed between the first and second sensing electrodes. The photosensitive spacers are spaced apart from one another by an interval extending in a first direction. The photosensitive spacers maintain a constant spacing between the first sending electrodes and the second sensing electrodes in a second direction.

According to exemplary embodiments, a method includes: forming first sensing electrodes on a first substrate of a touch screen; forming a photosensitive layer on the first sensing electrodes; patterning the photosensitive layer with a photolithographic mask to form photosensitive spacers at substantially regular intervals, each of the photosensitive spacers comprising substantially the same height; and forming an insulating layer on the first sensing electrodes.

The foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a perspective view schematically illustrating a touch screen panel, according to exemplary embodiments.

FIG. 2 is a sectional view taken along line I-I′ of FIG. 1, according to exemplary embodiments.

FIGS. 3A, 3B, 4, 5, and 6 are respective sectional of a touch screen panel at various manufacturing stages, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

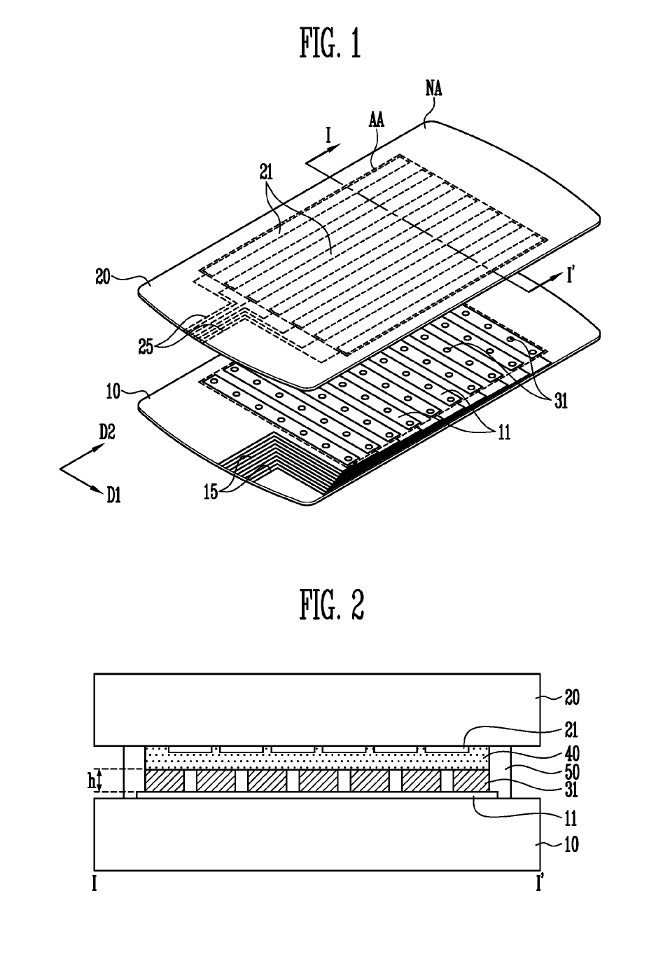

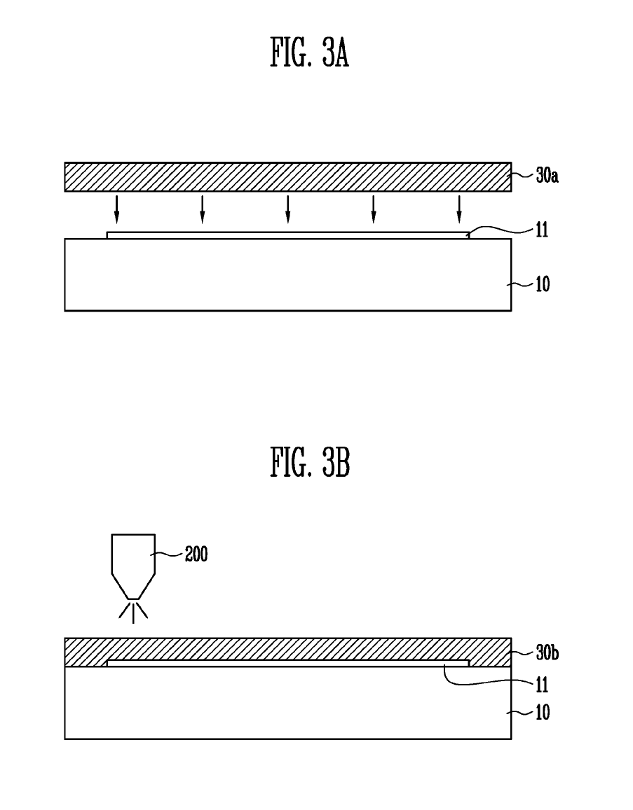

FIG. 1 is a perspective view schematically illustrating a touch screen panel, according to exemplary embodiments. FIG. 2 is a sectional view taken along line I-I′ of FIG. 1.

Referring to FIGS. 1 and 2, the touch screen panel may include a first substrate 10, first sensing electrodes 11, first outer lines 15, a second substrate 20, second sensing electrodes 21, second outer lines 25, photosensitive spacers 31, an insulating layer 40, and a sealing member 50. Although specific reference will be made to this particular implementation, it is also contemplated that the touch screen panel may embody many forms and include multiple and/or alternative components. For example, it is contemplated that the components of the touch screen panel may be combined, located in separate structures, and/or separate locations.

The first substrate 10 and the second substrate 20 are disposed opposite each other. The first substrate 10 or second substrate 20 may be divided into an active area AA, in which the first sensing electrodes 11 or the second sensing electrodes 21 are formed, so that a touch input can be performed therethrough, and a non-active area NA positioned outside the active area AA. The non-active area NA may include the first outer (or connecting) lines 15 or the second outer (or connecting) lines 25.

The active area AA is overlapped with an image display area, and the non-active area NA is a light-shielding area overlapped with an image non-display area. The non-active area NA may surround the active area AA.

Any one of the first substrate 10 and the second substrate 20 may be a window substrate provided at (or on) a front side of the touch screen panel. The first substrate 10 and the second substrate 20 may be made of any suitable material having sufficient flexibility and transparency, as well as relatively high thermal and chemical resistance. For example, each of the first substrate 10 and the second substrate 20 may be a thin-film substrate formed of one or more materials, such as polyethylene terephthalate (PET), polyimide (PI), polyethylene (PE), polycarbonate (PC), polyamide (PA), polymethylmethacrylate (PMMA), triacetyl cellulose (TAC), polyethersulfone (PES), and/or the like.

The first sensing electrodes 11 may form a plurality of lines that are distributed and arranged at an interval in the active area AA of the first substrate 10, and are electrically connected along a first direction D1. The second sensing electrodes 21 may form a plurality of lines that are distributed and arranged at an interval in the active area AA of the second substrate 20, and are electrically connected along a second direction D2 intersecting the first direction D1.

The first sensing electrodes 11 and the second sensing electrodes 21 may be formed of any suitable transparent material, such as aluminum zinc oxide (AZO), gallium zinc oxide (GZO), indium tin oxide (ITO), indium zinc oxide (IZO), etc., so that light can be transmitted therethrough. It is also contemplated that one or more conductive polymers (ICP) may be utilized, such as, for example, polyaniline, poly(3,4-ethylenedioxythiophene) poly(styrenesulfonate) (PEDOT:PSS), etc. The first sensing electrodes 11 or the second sensing electrodes 12 may be formed by depositing the transparent material on the first substrate 10 or the second substrate 20, and then patterning the deposited transparent material using any suitable technique, e.g., one or more photolithographic methods.

Although it has been described that each of the first sensing electrodes 11 and the second sensing electrodes 21 is formed with linear stripe patterns, the material and shape of each of the first sensing electrodes 11 and the second sensing electrodes 21 may be modified in various other ways, and exemplary embodiments are not limited thereto. For example, each of the first electrodes 11 and the second electrodes 21 may not be formed in the shape of a plurality of lines in FIG. 1, but formed in the shape of a plane in the entire active area AA. Alternatively (or additionally), each of the first electrodes 11 and second electrodes 21 may be formed in the shape of a metal mesh implemented with fine metal lines rather than lines made of the transparent material.

The first outer lines 15 allow the first sensing electrodes 11 to be electrically connected to an external driving circuit (not shown). The second outer lines 25 allow the second sensing electrodes 21 to be electrically connected to the external driving circuit. In exemplary embodiments, the first outer lines 15 and the second outer lines 25 are arranged in the non-active area NA at the outside of the touch screen panel to avoid the active area AA, in which an image is displayed. Because the material of the first outer lines 15 and the second outer lines 25 is selected from a wide range of choices, the first outer lines 15 and the second outer lines 25 may be formed of not only a transparent electrode material used to form the first sensing electrodes 11 and the second sensing electrodes 21, but may additionally or alternatively include a low-resistance metallic material, such as, for example, molybdenum (Mo), silver (Ag), titanium (Ti), copper (Cu), aluminum (Al), Mo/Al/Mo, etc., or a combination thereof. To this end, it is noted that the first and second sensing electrodes 11 and 21 and/or the first and second outer lines 15 and 25 may be single or multilayer structures.

The photosensitive spacers 31 are disposed between the first sensing electrodes 11 and the second sensing electrodes 21, and perform the function of maintaining a space (e.g., a constant space) between the first electrodes 11 and the second electrodes 21 at an interval (e.g., a regular interval); however, it is contemplated that any other suitable spacing scheme may be utilized.

The photosensitive spacers 31 are formed by patterning a photosensitive layer disposed on the first sensing electrodes 11. The photosensitive layer may be formed by laminating a dry film resist (DFR) or coating a photosensitive solution (liquid photoresist). It is contemplated, however, that any other suitable technique may be utilized. According to exemplary embodiments, the photosensitive layer may have a highly uniform thickness, and, as such, the photosensitive spacers 31 formed by patterning the photosensitive layer may also have a uniform height h. For example, the height of the photosensitive spacers 31 may be 0.1 mm, and the interval between the photosensitive spacers 31 may be 1 to 2 mm.

According to exemplary embodiments, when viewed from the top of the touch screen panel, the shape of the photosensitive spacers 31 is a circle, and the photosensitive spacers 31 are arranged on the first sensing electrodes 11. However, the shape of the photosensitive spacers 31 may be a polygon or any other free-form shape. Further, the photosensitive spacers 31 may be arranged in spaces between the first sensing electrodes 11. It is also noted that the photosensitive spacers 31 may have an elasticity with which the photosensitive spacers 31 can recover their original form after the height h of the photosensitive spacers 31 is varied. In other words, the photosensitive spacers 31 are elastically deformable.

The insulating layer 40 may be disposed between the first sensing electrodes 11 and the second sensing electrodes 11 so as to prevent the first sensing electrodes 11 and the second sensing electrodes 21 from being electrically connected to each other.

According to exemplary embodiments, the sealing member 50 may be provided to hermetically seal the touch screen panel. The sealing member 50 may be formed at an edge area of either the first substrate 10 or the second substrate 20. To this end, the sealing member 50 may also function to couple the first and second substrates 10 and 20 to one another.

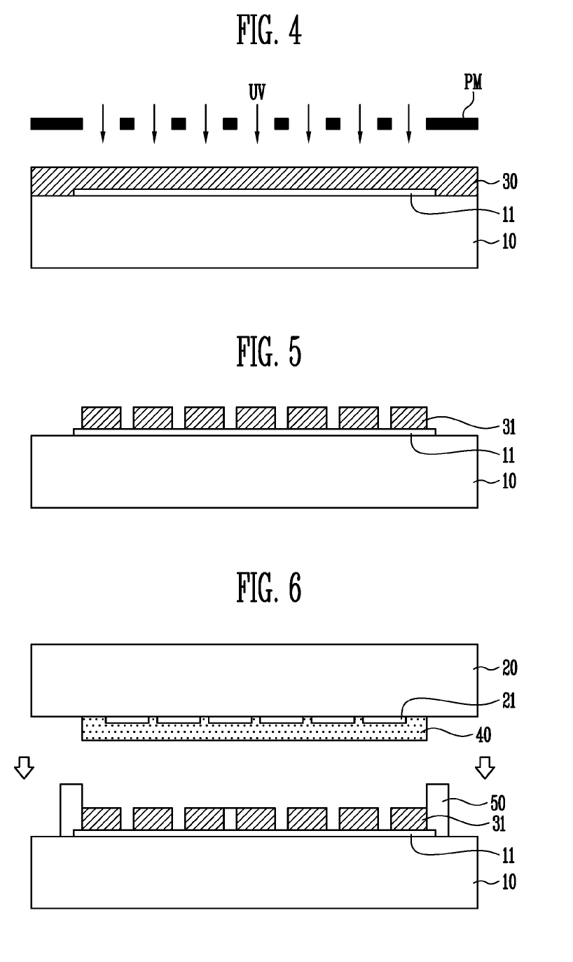

FIGS. 3A, 3B, 4, 5, and 6 are sectional views of a touch screen panel at various stages of manufacture, according to exemplary embodiments.

Referring to FIGS. 3A and 3B, first sensing electrodes 11 are formed on a first substrate 10, and a photosensitive layer is formed on the first sensing electrodes 11. That is, the first sensing electrodes 11 may be formed by depositing a conductive layer using a transparent conductive material, and patterning the deposited conductive layer. For example, the conductive layer may be deposited through a sputtering process. In the patterning process, a photography process and an etching process may be performed using a mask (not shown) in which patterns corresponding to the first sensing electrodes 11 are formed. The sputtering process may include physical vapor deposition (PVD), chemical vapor deposition (CVD), plasma-enhanced chemical vapor deposition (PECVD), and/or the like. It is contemplated, however, that any other suitable technique may be utilized to form the first sensing electrodes 11.

In exemplary embodiments, the first sensing electrodes 11 may be formed of a metallic nanowire material, such as indium tin oxide (ITO), silver nanowire (AgNW), etc. The photosensitive layer may be formed by laminating a photosensitive film 30a on the first sensing electrodes 11 or by spraying or coating a photosensitive solution 30b on the first sensing electrodes 11, using a spray device 200. When the photosensitive film 30a is used, a product previously produced through a roll-to-roll process, or the like, can be used as the photosensitive film 30a, thereby improving productivity. When the photosensitive solution 30b is used, it is possible to implement a reduced thickness of the photosensitive layer.

Referring to FIGS. 4 and 5, photosensitive spacers 31 are formed by patterning the photosensitive layer 30 (including 30a or 30b). The photosensitive spacers 31 may be formed by exposing and developing the photosensitive layer 30 using a photolithography method. For instance, the exposure process for the photosensitive layer 30 may be performed by disposing a photomask PM, in which patterns corresponding to the respective photosensitive spacers 31 are formed, and allowing the photomask PM to be exposed to a light source, such as ultraviolet (UV).

A development process is performed, which includes removing an area exposed through the exposure process or an area not exposed through the exposure process, using a developing solution. Patterns remaining after the development process are the photosensitive spacers 31. In addition, a baking process of applying heat to the photosensitive spacers 31 may be further performed in order to reinforce the strength of the photosensitive spacers 31 and to improve the coupling between the photosensitive spacers 31 and the first sensing electrodes 11.

Referring to FIG. 6, the first substrate 10, on which the photosensitive spacers 31 and the first sensing electrodes 11 are formed, and a second substrate 20 having second sensing electrodes 21 formed thereon, are joined together. It is noted that an insulating layer 40 may be previously formed on the second sensing electrodes 21, so as to prevent the first sensing electrodes 11 and the second sensing electrodes 21 from being electrically connected to each other. The insulating layer 40 may be deposited on a front side of the second substrate 20 on which the second sensing electrodes 21 are formed.

A sealing member 50 for hermetically sealing the touch screen panel may be formed at an edge area of the first substrate 10. In this manner, the sealing member 50 may be utilized to join the first substrate 10 and the second substrate 20 together, as well as hermetically seal at least the area occupied by the first sensing electrodes 11 and the second sensing electrodes 21.

Although not shown, the first outer lines 15 and the second outer lines 25 for connecting the first sensing electrodes 11 and the second sensing electrodes 21, respectively, to outsides of the touch screen panel may be previously formed on the first and second substrates 10 and 20, respectively.

Although it has been illustrated and described that the first sensing electrodes 11 are formed on the first substrate 10, the photosensitive spacers 31 are formed, and the first substrate 10 and the second substrate 20 are joined together, exemplary embodiments are not limited to such a manufacturing scheme. That is, the order of the processes may be changed, or other and/or additional processes may be added.

It is noted that conventional touch screen panels (including capacitive and resistive overlay types), may include spacers formed using a screen printing technique. In this manner, when the spacers are formed using a screen printing technique, the shapes of the spacers may not be equal because of variations in the viscosity of the material of the spacers and in the printing conditions of the spacers. Therefore, the heights of the spacers having a semicircular shape may differ. As such, the use of the screen printing technique may produce variations in the height of the spacers. This variation(s) has influence on capacitance, which may be generally determined according to Equation 1.

C=(εᵣ)*(εₒ)*A/d Eq. 1

where:

C=capacitance;

A=area of overlap between the first sensing electrodes 11 and the second sensing electrodes 21;

εᵣ=effective static permittivity (or dielectric constant) of the materials disposed between the first sensing electrodes 11 and the second sensing electrodes 21;

εₒ=electric constant (≈8.854*10⁻¹² F/m); and

d=spacing (or distance) between the first sensing electrodes 11 and the second sensing electrodes 21.

It is noted that the distance d between the first sensing electrodes 11 and the second sensing electrodes 21 is relied upon to detect touch events, as a change in distance d affects capacitance, and, therefore, corresponds to a touch event. In this manner, a touch screen panel including spacers formed using a screen printing technique may easily malfunction due, at least in part, to the variability in the distance d. As such, the touch detection quality of such a touch screen panel may be reduced.

According to exemplary embodiments, the photosensitive spacers 31 are configured to maintain a constant spacing between the first sensing electrodes 11 and the second sensing electrodes 21. To this end, the photosensitive spacers 31 are formed by patterning the photosensitive layer 30 (or DFR) at an interval (e.g., regular interval), so that the photosensitive spacers 31 can be formed with equal heights at the same interval. In this manner, the spacing between the first sensing electrodes 11 and the second sensing electrodes 21 can be held constant without any variation in height between the photosensitive spacers 31. To this end, it also noted that the width of the interval facilitates elastic deformation of the photosensitive spacers 31 without imposing undue stress or strain on the sealing member 50.

Although certain exemplary embodiments and implementations have been described herein, other embodiments and modifications will be apparent from this description. Accordingly, the invention is not limited to such embodiments, but rather to the broader scope of is the presented claims and various obvious modifications and equivalent arrangements.

What is claimed is:

1. A method of manufacturing a touch screen panel, the method comprising:
forming first sensing electrodes on a first substrate;
forming second sensing electrodes on a second substrate;
forming a photosensitive layer on the first sensing electrodes;
patterning the photosensitive layer to form photosensitive spacers spaced apart from one another in a first direction; and
joining the first substrate and the second substrate together,
wherein the photosensitive spacers maintain a substantially constant space between the first sensing electrodes and the second sensing electrodes in a second direction.

2. The method of claim 1, wherein the photosensitive layer comprises a dry film resist.

3. The method of claim 1, wherein the photosensitive layer is formed by coating a photosensitive solution on the first substrate.

4. The method of claim 1, wherein patterning the photosensitive spacers comprises exposing and developing the photosensitive layer using a photolithographic method.

5. The method of claim 4, further comprising curing the exposed and developed photosensitive spacers.

6. The method of claim 1, further comprising forming an insulating layer on the second sensing electrodes.

7. The method of claim 1, further comprising forming a sealing member on an edge area of the first substrate or the second substrate.

8. The method of claim 1, wherein:
the first sensing electrodes comprise lines longitudinally extending in the first direction and spaced apart from one another in a third direction;
the second sensing electrodes comprise lines longitudinally extending in the third direction and spaced apart from one another in the first direction; and
the first direction crosses the third direction.

9. The method of claim 8, further comprising:
forming first connecting lines to connect the first sensing electrodes to a driving circuit; and
forming second connecting lines to connect the second sensing electrodes to the driving circuit.

10. The method of claim 9, wherein:
each of the first substrate and the second substrate is divided into an active area and a non-active area;
the first sensing electrodes and the second sensing electrodes are formed in the active area; and
the first connecting lines and the second connecting lines are formed in the non-active area.

11. The method of claim 1, wherein each of the first substrate and the second substrate comprises a thin-film substrate formed from polyethylene terephthalate (PET), polyimide (PI), polyethylene (PE), polycarbonate (PC), polyamide (PA), polymethylmethacrylate (PMMA), triacetyl cellulose (TAC), and polyethersulfone (PES).

12. A touch screen panel, comprising:
first sensing electrodes disposed on a first substrate;
second sensing electrodes disposed on a second substrate opposite the first substrate; and
photosensitive spacers disposed between the first and second sensing electrodes,
wherein the photosensitive spacers are spaced apart from one another by an interval extending in a first direction, and
wherein the photosensitive spacers maintain a substantially constant spacing between the first sensing electrodes and the second sensing electrodes in a second direction.

13. The touch screen panel of claim 12, wherein the photosensitive spacers comprise a patterned and developed photosensitive material.

14. The touch screen panel of claim 13, wherein the photosensitive material comprises a dry film resist.

15. The touch screen panel of claim 13, wherein the photosensitive material comprises a coated photosensitive solution.

16. The touch screen panel of claim 13, wherein:
the first sensing electrodes comprise lines longitudinally extending in the first direction and spaced apart from one another in a third direction;
the second sensing electrodes comprise lines longitudinally extending in the third direction and spaced apart from one another in the first direction; and
the first direction crosses the second direction.

17. The method of claim 10, wherein the non-active area at least partially surrounds the active area.

18. The touch screen panel of claim 8, wherein the first, second, and third directions are substantially orthogonal to one another.

19. A method, comprising:
forming first sensing electrodes on a first substrate of a touch screen;
forming a photosensitive layer on the first sensing electrodes;
patterning the photosensitive layer with a photolithographic mask to form photosensitive spacers at substantially regular intervals, each of the photosensitive spacers comprising substantially the same height; and
forming an insulating layer on the first sensing electrodes.

20. The method of claim 19, further comprising:
forming second sensing electrodes on a second substrate of the touch screen;
forming a sealing member on the first substrate or the second substrate; and
coupling the first and second substrates via the sealing member,
wherein the photosensitive spacers maintain a substantially constant distance between the first and second substrates.
